(19) United States
(12) Patent Application Publication
(10) Pub. No.: US 2017/0107422 A1
(43) Pub. Date: Apr. 20, 2017

(54) OIL RECOVERY METHOD OF RESTRAINING GAS CHANNELING DURING CO2 FLOODING PROCESS IN LOW-PERMEABILITY FRACTURED RESERVOIRS THROUGH TWO-STAGE GAS CHANNELING BLOCKING TECHNOLOGY

(71) Applicant: CHINA UNIVERSITY OF PETROLEUM, BEIJING, Beijing (CN)

(72) Inventors: Jirui Hou, Beijing (CN); Fenglan Zhao, Beijing (CN); Zhongchun Liu, Beijing (CN)

(21) Appl. No.: 14/778,053

(22) PCT Filed: Sep. 23, 2014
(86) PCT No.: PCT/CN2014/000865

§ 371 Date: Sep. 17, 2015

(30) Foreign Application Priority Data
Jul. 3, 2014 (CN) 201410315718.X

(51) Int. Cl. C09K 8/588; C09K 8/594; C08F 251/00; E21B 33/138; E21B 43/16

(52) U.S. Cl. CPC C09K 8/588; E21B 33/138; E21B 43/164; C08F 251/00; C09K 8/594

(57) ABSTRACT

The present invention provides a method of restraining gas channeling phenomena during CO2 flooding process in the low-permeability fractured reservoirs through two-stage gas channeling blocking treatment so as to increase oil recovery. The two-stage gas channeling blocking technology includes first-stage gas channeling control to block off fractures using high-strength gel which is formed by natural modified polymeric materials, and second-stage gas channeling control to block off relatively high-permeability layers in the low permeability matrix using aliphatic amine. The gas channeling is effectively controlled and the swept volume is enlarged during the process of CO2 flooding in low permeability fractured reservoirs, and the oil recovery is greatly improved by two-stage gas channeling blocking technology.

### TECHNICAL FIELD

The present invention relates to technical field of oil and gas stimulation, and particularly relates to a method of restraining gas channeling during CO2 flooding in low-permeability fractured reservoirs through two-stage gas channeling blocking technology to improve oil recovery.

### BACKGROUND

With rapid development of modern industry, the demands for oil and gas are increasing, however, most of the maturing fields have entered the stage of middle or high water cut, and stable production and tapping are more and more difficult. In order to maintain the stable production of crude oil, exploitation of low permeability oilfield has received great concern, and has become an important exploitation target now and in the future. Therefore, it is urgent to find scientific and effective means to explore the low permeability oilfield. At present, nearly 100 low permeability reservoirs have been explored in China, and their oil reserves accounts for 13% of total explored reserves of China. In the explored and unutilized oil in place in China's oil industry, most are low permeability oil reserves, and the oil reserves of low permeability reservoirs will be expected to increase to around 40%. Low permeability oilfield is a relative concept, and the standards or boundaries of the classification around the world vary by status of resource and techniques as well as economic conditions in different countries and different times. Generally, it can be divided into three categories: Class I with reservoir permeability of 50˜10×10⁻³ μm², Class II with reservoir permeability of 10˜1×10⁻³ μm², and Class III with reservoir permeability of 1˜0.1×10⁻³ μm². During the National Tenth Five-Year Plan period of China, the proportion of explored oil and gas reserves of low permeability reservoirs is increasing year by year, even in recent years, 80% of annual discovered reserves are low permeability reservoirs. Obviously, effective exploitation and utilization of this portion of resource is an important direction for sustainable exploitation of oilfield. Due to the limitations of economic policy and technical level, the proportion of low permeability reservoirs presently being explored is only about 50%, and the mainly exploitation method is conventional water injection. Since the low permeability oilfields have poor physical property of reservoirs, low abundance of reserves, severe heterogeneity, complex pore structure, and other special properties, the quality of injected water needs higher requirement as long as complex water technology. Moreover, it is easy to form a passive situation of “incapable of injecting and incapable of exploiting” during the development of low permeability reservoirs. Meanwhile, waterflooding efficiency is also low, and the oil layers cannot be sufficiently exploited. The exploitation of low permeability sandstone reservoirs is so difficult that it has become the focus of reservoir engineering experts at home and abroad.

The low permeability oilfield, especially high pressure low permeability oilfield, has a high pressure and adequate natural energy at initial stage of exploitation. Generally, the exploitations of using elastic energy and dissolved gas drive energy are firstly employed, and followed by waterflooding after the oilfield entered low yield period. However, during the waterflooding process of the low permeability oilfield, there exist problems such as over-high waterflooding pressure, over-high waterflooding costs, severe permeability reduction of near wellbore, low production capacity, etc. Large number of researches and practices at home and abroad have proved that, since pore structure and seepage characteristic of the low permeability reservoirs are great different of middle and high permeability reservoirs due to the injection problem, adsorption problem, etc., chemical flooding EOR technology which has been applied in middle and high permeability reservoirs effectively cannot be applied in low permeability oilfield. Combined with the trend of environmental protection as well as energy saving and emission reduction, CO₂ flooding has the most application prospect among the EOR technologies of the low permeability oilfield as seen from the current technical developing situation. However, because of the severe heterogeneity of the low permeability reservoirs or the existing natural and artificial fractures, the injected water is difficult to sweep the remaining oil in the matrix, and gas channeling phenomenon also occurs obviously during the gas injection process due to the low seepage resistance. Therefore, the exploitation effect of simply water injection or gas injection is not ideal, and this is also a common technical problem around the world during CO₂ flooding process.

Exploiting the low permeability reservoirs with gas injection has its unique superiority, it not only does not exist injection problem, but also has the mechanisms that waterflooding does not possess. The injected gas can be miscible with reservoir crude oil under certain conditions, eliminating the effect of interfacial tension between displacing agents and displaced fluids. The seepage resistance can be greatly reduced, and as a result the oil recovery can be greatly improved. Even though the injected gas is immiscible with crude oil under reservoir conditions, the interphase mass transfer effect between oil and gas also can improve fluidity of the crude oil and enhance the oil recovery. The flooding efficiency of gas injection is better than waterflooding under certain geological conditions, and this has been confirmed by a large number of field tests. For example, the oil production of US Little Buffalo Basin Oilfield is improved by 45% after water-alternating-gas (WAG) injection was conducted compared with the oil production of waterflooding. The oil recovery of US JAY oilfield can be increased by 8% after WAG flooding; Field experiment of WAG flooding was also carried out in East Bei'er test area of Daqing oilfield, China, and three and a half years of WAG injection showed that, water cut of the production wells decreased and the oil production was higher than before. Miscible flooding was formed in Tallahassee mesa ude oilfield, Algeria using the produced associated gas re-injected into the oilfield with high pressure, and the gas injection volume reached a total of 6.6×10¹⁰ m³ until 1982. 1.22×10⁸ t of crude oil has been exploited by using high-pressure gas flooding, which accounts for 28% of cumulative oil production. Many indoor and field researches have demonstrated that, CO₂ flooding possesses obvious technical advantages compared with water flooding. CO₂ flooding can not only overcome the high injection pressure problem of waterflooding in the low permeability oilfield, but also can significantly change the fluidity of the crude oil. However, CO₂ flooding also creates some technical problems. For example, viscous fingering phenomena will be more severe since gas/oil mobility ratio is much larger than water/oil mobility ratio, and different degrees of gravity override will occur since density difference between oil and gas is larger than density difference between oil and water. As for the heterogeneity reservoirs, especially when there creates fractures or large pore paths, more severe gas channeling phenomena will occur during gas flooding process. Therefore, in order to achieve better CO₂ flooding efficiency, CO₂ channeling phenomena must be controlled to enlarge the swept volume, and cause a maximum contact between CO₂ and remaining oil. Many reservoirs conducted with CO₂ flooding are low permeability reservoirs, and conventional water injection is difficult, but injection of CO₂ also exists obvious gas channeling phenomena. In addition, since the low permeability reservoirs often exists fractures with a certain density, there is of great loses for enlarging swept volume of gas injection. Obviously, because of the water injection problems to low permeability matrix under this condition, it is difficult to apply the conventional blocking technology which is mainly based on high viscosity gels. On the other hand, the gels used to block off the fractures require higher strength and strong ability of cementing with the matrix, as well as strong resistance to CO₂. It is difficult to find technical information which can be directly used to control the gas channeling phenomena during gas flooding in the low permeability reservoirs according to the existing literatures, and this is also the main technical problem for this research work. In addition, strong fracture blocking agents which are resistant to CO₂ also need to be developed.

### SUMMARY

The present invention aims to provide an innovational method of restraining gas channeling during CO₂ flooding in the low-permeability fractured reservoirs through two-stage gas channeling blocking technology to improve oil recovery.

The method of restraining gas channeling during CO₂ flooding in the low-permeability (permeability ≦50×10⁻³ μm²) fractured reservoirs through two-stage gas channeling blocking technology as provided by the present invention includes the following steps:

1) First-stage gas channeling blocking treatment: first-stage gas channeling blocking treatment is achieved by using high-strength gels to block off fractures.

The fractures can be artificial fractures or nature fractures between injection well and any production well, which can result in channeling of the injected water or injected CO₂.

Since the fractures are strong channels for the injected gas, high-strength gels are required for the blocking treatments.

The high-strength gel is formed by the following parts by mass of materials via graft polymerization and crosslinking: 1-5 parts of natural modified polymer material, 1-5 parts of monomer, 0.01-0.3 parts of crosslinking agent, 0.001-0.3 parts of initiator, and 0-0.5 parts of stabilizer. The gelling process can normally proceed under acidic condition formed by injected CO₂ in advance (Generally the differential pressure of CO₂ flooding is 1-8 MPa).

The natural modified polymer material is selected from at least one of the following: carboxymethyl starch, carboxyethyl starch, hydroxyethyl starch, hydroxypropyl starch, α-starch, hydroxypropyl guar, carboxymethyl cellulose, and alkali cellulose;

The monomer is allyl monomer, and the allyl monomer is selected from at least one of the following: acrylamide, methacrylamide, acrylonitrile, acrylic acid, methacrylic acid, sodium acrylate, sodium methacrylate, and acrylate;

The crosslinking agent is selected from at least one of the following: bisacrylamide, N,N′-methylene-bis-acrylamide, and N-methylolacrylamide;

The initiator is selected from at least one of the following: potassium persulfate, ammonium persulfate, hydrogen peroxide, and benzoyl peroxide;

The stabilizer is selected from at least one of the following: sodium sulfite and sodium thiosulfate.

The high-strength gel is preferably formed by following parts by mass of the materials via graft polymerization and crosslinking: 4 parts of α-starch, 4 parts of acrylamide, 0.1 parts of N,N′-methylene-bis-acrylamide, 0.1 parts of potassium persulfate, and 0.2 parts of sodium sulfite.

The specific method of first-stage gas channeling blocking treatment includes the following steps: mix the materials and water (For example, oilfield injection water or field fresh water) to prepare a solution with the mass concentration of 2%-10% which can form a high-strength gel, and inject the solution into the fractures under the pressure which is less than formation breakdown pressure, and then waiting for gelling. When blocking off the fractures, the injection volume of gel is close to the pore volume of the fractures which is calculated according to geological cognition and dynamic data of field injection and production.

The time of waiting for gelling is 24 h-120 h.

2) Second-stage gas channeling blocking treatment: second-stage channeling blocking treatment is achieved by using aliphatic amine to block off the channeling of low viscosity CO₂ in relative high permeability layer zones in low permeability matrix.

Boiling point of the aliphatic amine is close to the reservoir temperature.

The aliphatic amine is selected from at least one of the following: methylamine and derivatives thereof, ethylamine and derivatives thereof, propylamine and derivatives thereof, butylamine and derivatives thereof, and ethylene diamine and derivatives thereof. Ethylenediamine is preferred.

In step 2), the aliphatic amine is injected into relative high permeability layer which has the occurrence of CO₂ channeling in the matrix. The blocking effect is achieved by carbamate which is produced by the reaction between the aliphatic amine and CO₂ remained in the gas channels. Liquid nitrogen is first injected into the formation as isolating slug, followed by the aliphatic amine, liquid nitrogen is injected again as subsequent isolating slug to avoid blocking near the wellhead, and then CO₂ is directly injected to continue gas flooding without waiting for gelling.

Generally, injection volume of the aliphatic amine is ⅕-⅓ of pore volume of CO₂ channels (CO₂ channels occurred in relative high permeability layers in the matrix) which need to be calculated according to geological recognition and dynamic data of field injection and production.

If there exists a plurality of directions and a plurality of different permeability of high permeability layers in low permeability matrix, different degrees of gas channeling in a plurality of directions will occur during CO₂ flooding, and the second-stage gas channeling blocking method can be performed for multiple runs until the final recovery degree meets the requirement (Highest permeability layer zone in each run is successively blocked off).

Second-stage gas channeling blocking treatment includes the following steps: liquid nitrogen is injected into the formation as isolating slug, then the aliphatic amine is injected into the highest permeability layer in the matrix which has the occurrence of CO₂ channeling with the pressure not higher than 20% of CO₂ injection pressure (It can be guaranteed that the aliphatic amine only enters CO₂ channels under this condition). Liquid nitrogen is injected again as subsequent isolating slug, and then CO₂ is directly injected to continue gas flooding without waiting for gelling. Injection volume of the liquid nitrogen can be 1-2 tons.

The method of exploiting low permeability fractured reservoirs employing the two-stage gas channeling blocking technology also belongs to the protection scope of the present invention.

The method of exploiting the low permeability fractured reservoirs includes the following steps:

A1. Waterflooding is performed to exploit the low permeability fractured reservoirs.

B1. First-stage gas channeling blocking treatment (The solution which can form high-strength gel is injected into fractures and wait for gelling) is performed after occurring obvious fracture channeling characteristic during waterflooding (The water content of the production fluid exceeds 98%, and characteristic curve of water cut index is concave), and then CO₂ flooding is conducted in the low permeability fractured reservoirs.

C1. First operation of the second-stage gas channeling blocking treatments is performed after CO₂ channeling occurs in relative high permeability layers in low permeability matrix (A large amount of CO₂ is continuously outputted and the oil production is not increased in some production wells). Liquid nitrogen is first injected into the formation (The injection volume of liquid nitrogen can be 1 ton) as isolating slug, then the gas channeling blocking agent of aliphatic amine is injected according to the design volume which is generally 5 tons to 15 tons, and then 1 ton of liquid nitrogen is injected again as subsequent isolating slug, followed by CO₂ injection to continuous CO₂ flooding without waiting for gelling.

D1. After CO₂ channeling occurred again in the relative high permeability layers in low permeability matrix, step C1 can be repeated until the overall recovery meets the requirement.

According to the characteristic of reservoirs and the needs of exploitation, CO₂ flooding is first performed after waterflooding in some low permeability oilfields. Fractures in the formation are filled with gas after CO₂ flooding and CO₂ channeling always occurs along the fractures. First-stage gas channeling blocking treatment also can be performed under this condition with injecting the solution into fractures which can form high-strength gel (Gelling process will not be affected under acidic condition). CO₂ is injected into the formation after the gel cemented for enough time, and then repeat step C1.

The specific method includes the following steps:

A2. Waterflooding is firstly performed to exploit the low permeability fractured reservoir; and then CO₂ flooding is conducted after waterflooding.

B2. First-stage gas channeling blocking treatment (The solution which can form high-strength gel is injected into fractures and wait for gelling) is performed after occurring obvious CO₂ channeling characteristic along the fracture during CO₂ flooding. (A large amount of CO₂ is outputted from the wells along fracture direction, but little gas is outputted from the wells across the fracture direction), and then CO₂ is injected into the formation to continue gas flooding.

C2. First operation of the second-stage gas channeling blocking treatments is performed after —CO₂ channeling occurs in relative high permeability layers in low permeability matrix (A large amount of CO₂ is continuously outputted and the oil production is not increased in some production wells). Liquid nitrogen is first injected into the formation (The injection volume of liquid nitrogen can be 1 ton) as isolating slug, then the gas channeling blocking agent of aliphatic amine is injected according to the design volume which is generally 5 tons to 15 tons, and then 1 ton of liquid nitrogen is injected again as subsequent isolating slug, followed by CO₂ injection to continuous CO₂ flooding without waiting for gelling.

D2. After CO₂ channeling occurred again in the relative high permeability layers in low permeability matrix, step C2 can be repeated until the overall recovery meets the requirement.

Specific to the different gas channeling phenomena during the process of CO₂ flooding in the low permeability reservoirs, the present invention performs the method of two-stage gas channeling blocking technology to improve the oil recovery. Firstly, CO₂ channeling along the fractures is blocked off by first-stage gas channeling blocking treatment, and then gas channeling along the relative high permeability layers in low permeability matrix is blocked off by second-stage gas channeling blocking treatment.

### BRIEF DESCRIPTION OF THE DRAWINGS

FIG. 1 is a low permeability fractured physical model of radial flow.

FIG. 2 is a flow chart of the overall flooding oil simulation experiment.

FIG. 3 is a summary of various stages of channeling blocking effect of Example 1.

FIG. 4 is a summary of various stages of channeling blocking effect of Example 2.

FIG. 5 is a summary of various stages of channeling blocking effect of Example 3.

### DETAILED DESCRIPTION OF THE INVENTION

The experimental methods used in the following examples are all conventional methods unless special descriptions, and the agents, materials, etc. used in the following examples all can be obtained from commercial sources unless special descriptions.

The following examples are based on low permeability physical model of radial flow, and the fractures and relative high permeability layers in the matrix are considered in the physical model. FIG. 1 is the low permeability fractured physical model of radial flow.

### Example 1

Experiment Conditions:

The size of the physical model is φ 400 mm×60 mm, the physical model is made of natural outcrop by drilling, cutting, polishing. One injection well and four production wells are designed according to five-spot well pattern.

The permeability between the injection well and the four production wells is also different because of the dense degree of the natural outcrop. This heterogeneity can reflect the real conditions of the oilfield.

The physical property of Model 1 and the permeability of four directions along the injection and production wells are shown in Table 1.

TABLE 1
Permeability of the radial flow model along the
directions of four production wells in Example 1

| | Flow rate | Differential | Permeability of the |
|---|---|---|---|
| | (mL/min) | pressure (KPa) | matrix (mD) |
| 1^{#} | 0.1 | 888.39 | 0.218 |
| 2^{#} | 0.4 | 138.61 | 5.62 |
| 3^{#} | 0.4 | 122.51 | 6.39 |
| 4^{#} | 0.5 | 51.81 | 18.74 |

In addition, fractures are made by artificial fracturing between Well 1^{#} and Well 3^{#} in order to simulate the fractures of oilfield. A small amount of quartz sand with particle size of about 0.3 mm serving as fracture proppant is filled in fractures, and the fracture permeability is 12762.3 mD.

Experimental Procedure and Equipment:

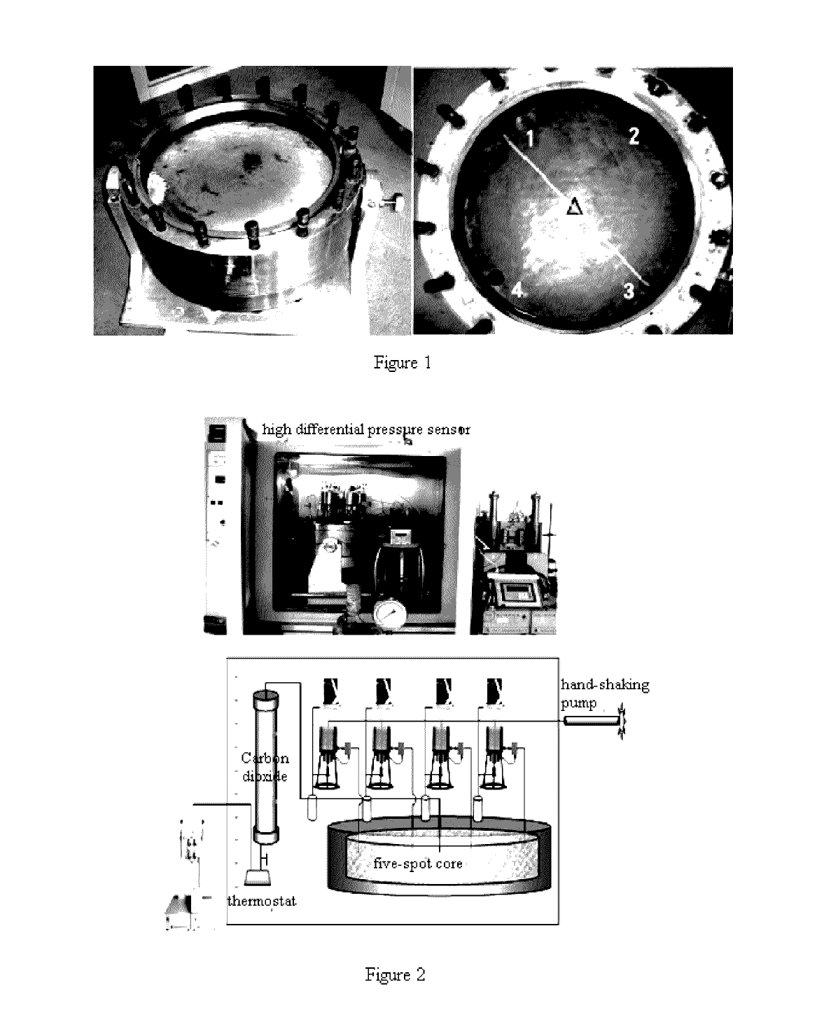

FIG. 2 is the procedure of the flooding experiment, which is composed by four parts: fluid feeding system, experimental model, measuring system, and temperature control system.

The fluid feeding system includes high-pressure pump and relevant intermediate containers, which are used for simulating constant speed injection.

The measuring system is divided into two parts: the first part is the pressure transmission system, including pressure sensors and process module; and the second part is a flow metering system including high pressure CO₂ gas flowmeter which can accurately measure injection and production volume of the liquid and gas. The temperature within thermostat is set according to formation temperature, and the experiment is performed under the condition of formation temperature. Back pressure is controlled at 7.0 MPa, the injection pressure is 8.0 MPa, and the peripheral pressure of the model is 12 MPa.

Experiment Method and Result Analysis:

(1) Fractures are artificially made between Well 1^{#} and Well 3^{#} after the physical model is saturated with the crude oil, and then waterflooding is firstly performed according to field procedure.

Oil is outputted in Well 1^{#}, Well 3^{#}, and Well 4^{#} in this stage, however, no oil is outputted in Well 2^{#} because the permeability of the matrix is low and no fracture exists along Well 2^{#} direction (Seen the list of waterflooding in Table 2).

(2) First-stage gas channeling blocking treatment is performed after obvious water channeling occurs during waterflooding. Fractures are blocked off using the high-strength gel made of natural modified polymer material, the component of the strong gel system includes 4 parts of α-starch, 4 parts of acrylamide, 0.1 parts of N,N′-methylene-bis-acrylamide, 0.1 parts of potassium persulfate, and 0.2 parts of sodium sulfite. The gel solution with mass concentration of 8% is prepared using oilfield injection water, and 18 mL of gel solution is injected into the fractures under the injection pressure which is less than formation breakdown pressure. CO₂ is injected into the model to perform the first CO₂ flooding after waiting on cement for 48 h.

Since the fractures along Well 1^{#} and Well 3^{#} directions are blocked off by gel in this stage, and the injected CO₂ gives priority to flow through the directions with relatively high permeability, oil is only outputted in Well 2^{#} and Well 4^{#} during first gas flooding (Seen the list of the first gas flooding in Table 2), and CO₂ channeling phenomenon first occurs in Well 4^{#}.

(3) First operation of second-stage gas channeling blocking treatment is performed after continuous CO₂ is outputted and no oil is produced in Well 4^{#}. In order to block off the gas channels between Injection Well and Well 4^{#}, 4 mL of N₂ is injected as isolating slug, and then 20 mL of ethylenediamine which is designed is injected into the model, followed by 4 mL of N₂ as subsequent isolating slug. Second gas flooding is performed after the first operation of second-stage gas channeling blocking treatment.

In this stage, since relative high permeability layers in the matrix along Well 4^{#} direction has been blocked off by salt generated by the reaction between ethylenediamine and CO₂, liquid cannot be outputted in Well 4^{#}. The oil is mainly produced in Well 1^{#}, Well 2^{#}, and Well 3^{#} (Seen the list of the second gas flooding in Table 2), and CO₂ channeling phenomenon occurs again in Well 3^{#} after continuous CO₂ injection.

(4) Second operation of second-stage gas channeling blocking treatment is performed after continuous CO₂ is outputted and no oil is produced in Well 3^{#}. In order to block off the gas channels between Injection Well and Well 3^{#}, 4 mL of N₂ is injected as isolating slug, and then 18 mL of ethylenediamine which is designed is injected into the model, followed by 4 mL of N₂ as subsequent isolating slug. Third gas flooding is performed after the second operation of second-stage gas channeling blocking treatment.

In this stage, since relative high permeability layers in the matrix along Well 3^{#} direction has been blocked off by salt generated by the reaction between ethylenediamine and CO₂, liquid cannot be outputted in Well 3^{#}. Large amount of oil is produced in Well 1^{#}, Well 2^{#}, and small amount of oil is produced in Well 4^{#} (Seen the list of the Third gas flooding in Table 2). CO₂ channeling phenomenon occurs again along Well 2^{#} direction after continuous CO₂ injection.

(5) Third operation of second-stage gas channeling blocking treatment is performed after continuous CO₂ is outputted and no oil is produced in Well 2^{#}. In order to block off the gas channels between Injection Well and Well 2^{#}, 4 mL of N₂ is injected as isolating slug, and then 18 mL of ethylenediamine which is designed is injected into the model, followed by 4 mL of N₂ as subsequent isolating slug. Fourth gas flooding is performed after the third operation of second-stage gas channeling blocking treatment.

In this stage, since relative high permeability layers in the matrix along Well 2^{#} direction has been blocked off by salt generated by the reaction between ethylenediamine and CO₂, liquid cannot be outputted in Well 2^{#}. Large amount of oil is produced in Well 1^{#}, and small amount of oil is produced in Well 3^{#}, however, no oil is outputted in Well 4# (Seen the list of the fourth gas flooding in Table 2). The injection experiment is stopped until no oil is outputted in Well 1^{#} and Well 3^{#}.

Table 2 is the oil recovery of each stage of gas channeling blocking treatment in example 1.

TABLE 2
The oil recovery of each stage of gas channeling blocking treatment in example 1

| | | First gas | Second gas | Third gas | Fourth gas | The |
|---|---|---|---|---|---|---|
| | Waterflooding | flooding | flooding | flooding | flooding | total |
| Production | recovery η | recovery η | recovery η | recovery η | recovery η | recovery |
| wells | (%) | (%) | (%) | (%) | (%) | η(%) |
| 1^{#} | 2.2 | 0 | 3.0 | 8.2 | 5.3 | 18.7 |
| 2^{#} | 0 | 8.0 | 6.2 | 5.0 | 0 | 19.2 |
| 3^{#} | 5.0 | 0 | 12.0 | 0 | 2.2 | 19.2 |
| 4^{#} | 7.2 | 12.8 | 0 | 3.0 | 0 | 23.0 |
| total | 14.4 | 20.8 | 21.2 | 16.2 | 7.5 | 80.1 |
| Blocking | | Fractures | Gas | Gas | Gas | |
| treatment | | along Well | channels in | channels in | channels in | |
| of each | | 1^{#} and | the matrix | the matrix | the matrix | |
| stage | | Well 3^{#} are | along | along | along | |
| | | blocked | Injection | Injection | Injection | |
| | | off | Well and | Well and | Well and | |
| | | (First-stage | Well 4^{#} are | Well 3^{#} are | Well 2^{#} are | |
| | | gas | blocked off | blocked off | blocked off | |
| | | channeling | (First | (Second | (Third | |
| | | blocking | operation of | operation of | operation of | |
| | | treatment) | second-stage | second-stage | second-stage | |
| | | | gas | gas | gas | |
| | | | channeling | channeling | channeling | |
| | | | blocking | blocking | blocking | |
| | | | treatment) | treatment) | treatment) | |

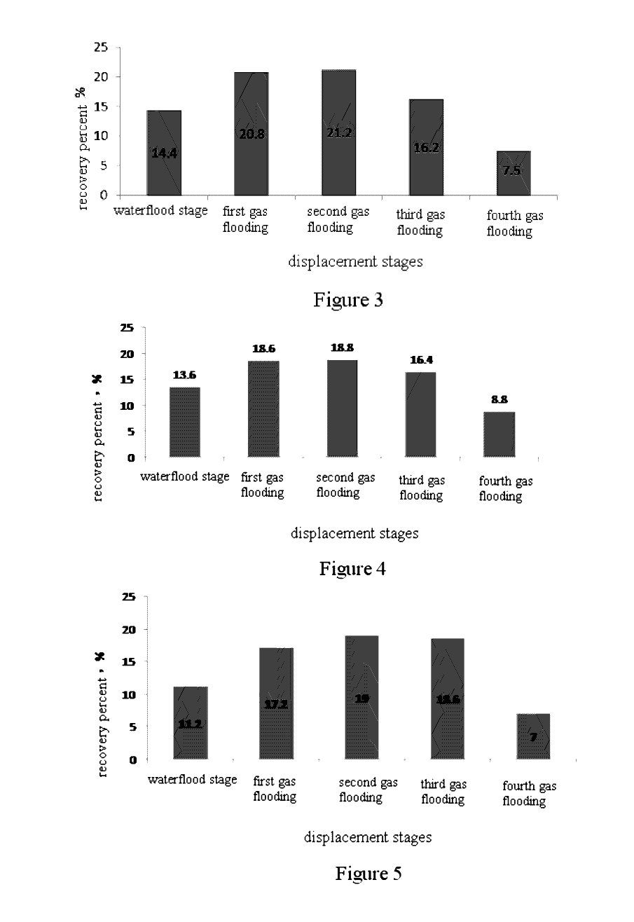

FIG. 3 is the summary of each stage of gas channeling blocking effect in Example 1.

It can be known from FIG. 3 that the blocking effect of two-stage gas channeling blocking treatment is obvious. The oil recovery increases from 14.4% of waterflooding to 80.1%, which means that the oil recovery increases by 65.7% through two-stage gas channeling blocking treatment. Moreover, the blocking effect of third operation of second-stage gas channeling blocking treatment is particularly significant.

However, economic factor should also be considered in actual field application. Blocking effect of each stage is shown in FIG. 3 in the present experiment. In the two-stage gas channeling blocking experiment, total oil recovery can be increased to 56.4% after the fractures are blocked off by first-stage gas channeling blocking treatment and the gas channels in the matrix are blocked off by first amine injection of second-stage gas channeling blocking treatment. This incremental oil recovery is close to the recovery of chemical flooding in conventional oilfield. If the economy factor allows, the total oil recovery can reach 72.6% when one more amine injection is performed in the second-stage gas channeling blocking treatment, which is far more than the recovery of chemical flooding in conventional oilfield, and there is no need to consider the third amine injection.

In order to verify the reliability of two-stage gas channeling blocking method, two more examples are proceeded in the present invention. Experimental procedures and equipment, and experimental method used in the following two examples are the same as Example 1. In order to investigate the repeatability of two-stage gas channeling blocking method, different experimental models are selected with different permeability. Besides, the experimental process of each stage and the sequence of conversion are also completely the same as Example 1 for better comparison (Seen as Example 2 and Example 3).

### Example 2

The physical property of Model 2 and the permeability of four directions along the injection and production wells are shown in Table 3.

TABLE 3
Permeability of the radial flow model along the
directions of four production wells in Example 2

| | Flow rate | Differential | Permeability of the |
|---|---|---|---|
| | (mL/min) | pressure (KPa) | matrix (mD) |
| 1^{#} | 0.1 | 997.63 | 0.194 |
| 2^{#} | 0.4 | 111.01 | 7.03 |
| 3^{#} | 0.4 | 168.92 | 4.63 |
| 4^{#} | 0.4 | 238.01 | 3.27 |

Similarly, fractures are made by artificial fracturing between Well 1^{#} and Well 3^{#}, and a small amount of silica sand with the particle size of about 0.3 mm serving as fracture proppant is filled in the fractures. The fracture permeability is 11876.5 mD.

Similarly, two-stage gas channeling blocking treatment is performed in the experiment. CO₂ flooding is conducted after the fractures are blocked off, and the gas channels of relative high permeability layers in the matrix are multiple blocked off when CO₂ channeling occurs in production wells. The results are shown in Table 4 and FIG. 4.

TABLE 4
The oil recovery of each stage of gas channeling blocking treatment in example 2

| | | First gas | Second gas | Third gas | Fourth gas | The |
|---|---|---|---|---|---|---|
| | Waterflooding | flooding | flooding | flooding | flooding | total |
| Production | recovery η | recovery η | recovery η | recovery η | recovery η | recovery |
| wells | (%) | (%) | (%) | (%) | (%) | η(%) |
| 1^{#} | 1.6 | 0 | 4.6 | 6.8 | 4.8 | 17.8 |
| 2^{#} | 5.2 | 11.4 | 0 | 4.2 | 1.2 | 22.0 |
| 3^{#} | 4.8 | 0 | 8.6 | 5.4 | 0 | 18.8 |
| 4^{#} | 2.0 | 7.2 | 5.6 | 0 | 2.8 | 17.6 |
| total | 13.6 | 18.6 | 18.8 | 16.4 | 8.8 | 76.2 |
| Blocking | | Fractures | Gas | Gas | Gas | |
| treatment | | along Well | channels in | channels in | channels in | |
| of each | | 1^{#} and | the matrix | the matrix | the matrix | |
| stage | | Well 3^{#} are | along | along | along | |
| | | blocked | Injection | Injection | Injection | |
| | | off | Well and | Well and | Well and | |
| | | (First-stage | Well 2^{#} are | Well 4^{#} are | Well 3^{#} are | |
| | | gas | blocked off | blocked off | blocked off | |
| | | channeling | (First | (Second | (Third | |
| | | blocking | operation of | operation of | operation of | |
| | | treatment) | second-stage | second-stage | second-stage | |
| | | | gas | gas | gas | |
| | | | channeling | channeling | channeling | |
| | | | blocking | blocking | blocking | |
| | | | treatment) | treatment) | treatment) | |

FIG. 4 is the summary of each stage of gas channeling blocking effect in Example 2. Similarly as Example 1, it can be known from FIG. 4 that the oil recovery increases from 13.6% of waterflooding to 76.2% after two-stage gas channeling blocking treatment, and the oil recovery increases by 62.6%. Although the permeability of Model 2 is much less than the permeability of Model 1, the blocking effect of two-stage gas channeling control is still significant. The oil recovery can reach 67.4% after two times of gas injection during second-stage gas channeling control period, which is far more than the recovery of chemical flooding in conventional oilfield.

### Example 3

The physical property of Model 3 and the permeability of four directions along the injection and production wells are shown in Table 5.

TABLE 5
Permeability of the radial flow model along the
directions of four production wells in Example 3

| | Flow rate | Differential | Permeability of the |
|---|---|---|---|
| | (mL/min) | pressure (kPa) | matrix (mD) |
| 1^{#} | 0.4 | 296.27 | 2.62 |
| 2^{#} | 0.4 | 350.5 | 2.23 |
| 3^{#} | 0.4 | 673.82 | 1.16 |
| 4^{#} | 0.4 | 609.22 | 1.28 |

In order to further investigate the ability of two-stage gas channeling blocking treatment to control the areal heterogeneity, two major fractures are artificially made to form a “V” type: one is from Injection Well to Well 1^{#} and the other is from Injection Well to Well 2^{#}. Small amount of silica sand with the particle size of about 0.3 mm serving as fracture proppant is filled in the fractures, and the fracture permeability is 12676.8 mD.

Same experimental procedures are operated in Example 3. CO₂ flooding is performed after waterflooding in the experiment, and the effect of gas channeling blocking treatment is investigated after two-stage gas channeling control. The experimental results are seen in Table 6 and FIG. 5.

TABLE 6
The oil recovery of each stage of gas channeling blocking treatment in example 3

| | | First gas | Second gas | Third gas | Fourth gas | The |
|---|---|---|---|---|---|---|
| | Waterflooding | flooding | flooding | flooding | flooding | total |
| Production | recovery η | recovery η | recovery η | recovery η | recovery η | recovery |
| wells | (%) | (%) | (%) | (%) | (%) | η(%) |
| 1^{#} | 2.9 | 0 | 7.4 | 5.0 | 1.8 | 17.1 |
| 2^{#} | 3.5 | 0 | 7.2 | 5.8 | 1.2 | 17.7 |
| 3^{#} | 2.2 | 8.8 | 0 | 7.8 | 0 | 18.8 |
| 4^{#} | 2.6 | 8.4 | 4.4 | 0 | 4.0 | 19.4 |
| total | 11.2 | 17.2 | 19.0 | 18.6 | 7.0 | 73.0 |
| Blocking | | Fractures | Gas | Gas | Gas | |
| treatment | | between | channels in | channels in | channels in | |
| of each | | Injection | the matrix | the matrix | the matrix | |
| stage | | Well and | along | along | along | |
| | | 1^{#}, and | Injection | Injection | Injection | |
| | | fractures | Well and | Well and | Well and | |
| | | between | Well 3^{#} are | Well 4^{#} are | Well 3^{#} are | |
| | | Injection | blocked off | blocked off | blocked off | |
| | | Well and | (First | (Second | (Third | |
| | | Well 2^{#} are | operation of | operation of | operation of | |
| | | blocked | second-stage | second-stage | second-stage | |
| | | off | gas | gas | gas | |
| | | (First-stage | channeling | channeling | channeling | |
| | | gas | blocking | blocking | blocking | |
| | | channeling | treatment) | treatment) | treatment) | |
| | | blocking | | | | |
| | | treatment) | | | | |

FIG. 5 is the summary of each stage of gas channeling blocking effect in Example 3. As shown in FIG. 5, although the two fractures form a “V” type, the areal heterogeneity is still regulated by the two-stage gas channeling blocking treatment. The oil recovery increases from 11.2% of waterflooding to 73.0% after the treatment, and the oil recovery increases by 61.8%. Because the permeability of the matrix along Well 3^{#} and Well 4^{#} directions is relative high, CO₂ channeling phenomenon occurs twice along Well 3^{#} direction, however, gas channeling phenomenon does not occur along Well 1# and Well 2^{#} directions after the fractures are blocked off by the gel. Furthermore, the areal heterogeneity is regulated and the pore throats of the model are more uniform after the gas channeling blocking treatment. The oil recovery can reach 67.0% after first-stage gas channeling control and two operations of second-stage gas channeling control, which is far more than the recovery of chemical flooding in conventional oilfield without the fourth gas flooding.

Two-stage gas channeling blocking technique can effectively control the gas channeling and enlarge the swept volume in low permeability fractured reservoirs during the process of CO₂ flooding. If the economic factors are not considered in the application, second-stage gas channeling blocking treatment can be multiple performed after the fractures are blocked off by first-stage gas channeling blocking treatment, and all the remaining oil can be recovered theoretically. In actual application, runs of second-stage gas channeling blocking treatment are needed to be controlled according to technical and economic restrictions, so as to obtain best economic benefits.

### INDUSTRIAL APPLICATION

Specific to the different gas channeling phenomena during the process of CO₂ flooding in low permeability fractured reservoirs, the present invention employs the method of two-stage gas channeling blocking treatment. Fractures are firstly blocked off by first-stage gas channeling blocking treatment, and then the gas channels in relative high permeability layers in the low permeability matrix are blocked off by second-stage gas channeling blocking treatment. The gas channeling is effectively controlled and the swept volume is enlarged during the process of CO₂ flooding in low permeability fractured reservoirs, and the oil recovery is greatly improved by two-stage gas channeling blocking technology.

1. A method of restraining gas channeling during CO₂ flooding in low-permeability fractured reservoirs through a two-stage gas channeling blocking technology including the following steps:
(1) a first-stage gas channeling blocking treatment, comprising: fractures blocked off using a high-strength gel so as to achieve a first-stage gas channeling control; wherein the high-strength gel is formed by the following parts by mass of materials via graft polymerization and crosslinking: 1-5 parts of a natural modified polymer, 1-5 parts of a monomer, 0.01-0.3 parts of a crosslinking agent, 0.001-0.3 parts of an initiator and 0-0.5 parts of a stabilizer; and
(2) a second-stage gas channeling blocking treatment, comprising: relative high permeability layers in a matrix of the low permeability fractured reservoirs in which CO₂ channels blocked off using an aliphatic amine to achieve a second-stage gas channeling control.

2. The method of claim 1, wherein in step (1), the natural modified polymer is selected from at least one of the following: carboxymethyl starch, carboxyethyl starch, hydroxyethyl starch, hydroxypropyl starch, α-starch, hydroxypropyl guar, carboxymethyl cellulose, and alkali cellulose;
the monomer is an allyl monomer which is selected from at least one of the following: acrylamide, methacrylamide, acrylonitrile, acrylic acid, methacrylic acid, sodium acrylate, sodium methacrylate, and acrylate;
the crosslinking agent is selected from at least one of the following: bisacrylamide, N,N′-methylene-bis-acrylamide, and N-methylolacrylamide;
the initiator is selected from at least one of the following: potassium persulfate, ammonium persulfate, hydrogen peroxide, and a benzoyl peroxide; and
the stabilizer is selected from at least one of the following: sodium sulfite and sodium thiosulfate.

3. The method of claim 1, wherein the first-stage gas channeling blocking treatment further comprising: a solution with the mass concentration of 2%-10% is mixed with the materials and water to form the high-strength gel, and then the solution is injected into the fractures under a pressure which is less than formation breakdown pressure; and the time of waiting for gelling is 24 h-120 h.

4. The method of claim 1, wherein in step (2) the aliphatic amine is selected from at least one of the following: methylamine and derivatives thereof, ethylamine and derivatives thereof, propylamine and derivatives thereof, butylamine and derivatives thereof, and ethylene diamine and derivatives thereof; preferably ethylene diamine.

5. The method of claim 1, wherein the second-stage gas channeling blocking treatment further comprising: liquid nitrogen is injected into the formation as an isolating slug, then the aliphatic amine is injected into the highest permeability layer in the matrix which has the occurrence of CO₂ channeling with the pressure not higher than 20% of CO₂ injection pressure. Liquid nitrogen is injected again as a subsequent isolating slug, and then CO₂ is directly injected to continue gas flooding without waiting for gelling.

6. The method of claim 5, wherein the injection volume of the aliphatic amine is generally ⅕-⅓ of the pore volume of gas channels, and the injection volume of liquid nitrogen is 1-2 tons.

7. The method of claim 1, further comprising the following steps:
(a1) waterflooding performed to exploit the low permeability fractured reservoirs;
(b1) the first-stage gas channeling blocking treatment performed after a water channeling characteristic occurs during waterflooding, and then CO₂ flooding is conducted in the low permeability fractured reservoirs, wherein said water channeling characteristic is that the water content of the production fluid exceeds 98%, and the characteristic curve of a water cut index is concave;
(c1) the second-stage gas channeling blocking treatment performed after CO₂ channeling occurs in the relative high permeability layers in the low permeability matrix, and then followed by CO₂ injection to continuous CO₂ flooding.

8. The method of claim 7, further comprising:
after CO₂ channeling occurred again in the relative high permeability layers in low permeability matrix, step (c1) is repeated until the overall recovery meets the requirement.

9. The method of claim 1, further comprising a method of exploiting low permeability fractured reservoirs, wherein:
(a2) waterflooding is firstly performed to exploit the low permeability fractured reservoir;
and then CO₂ flooding is conducted after waterflooding;
(b2) the first-stage gas channeling blocking treatment is performed after a CO₂ channeling characteristic occurs along the fracture during CO₂ flooding, and then CO₂ is injected into the formation to continue gas flooding, said CO₂ channeling characteristic is that a large amount of CO₂ is outputted but little gas is outputted from the production wells; and
(c2) the second-stage gas channeling blocking treatment is performed after CO₂ channeling occurs in the relative high permeability layers in the low permeability matrix, and then followed by CO₂ injection to continuous CO₂ flooding.

10. The method of claim 9, further comprising: after CO₂ channeling occurred again in the relative high permeability layer in the low permeability matrix, step (c2) is repeated until the overall recovery meets the requirement.
